(19) United States
(12) Patent Application Publication
(10) Pub. No.: US 2023/0024318 A1
(43) Pub. Date: Jan. 26, 2023

(54) MULTI-LAYER COEXTRUSION HEAD AND METHOD FOR MAKING A MULTI-LAYER PRODUCT

(71) Applicant: SACMI COOPERATIVA MECCANICI IMOLA SOCIETA' COOPERATIVA, 40026 IMOLA (BOLOGNA) (IT)

(72) Inventors: Fabrizio PUCCI, Castel Guelfo Di Bologna (IT); Davide BALDISSERRI, Imola (IT)

(21) Appl. No.: 17/769,229

(22) PCT Filed: Oct. 14, 2020
(86) PCT No.: PCT/IB2020/059655

§ 371 Date: Apr. 14, 2022

(30) Foreign Application Priority Data
Oct. 16, 2019 (IT) 102019000019013

(51) Int. Cl. B29C 48/305; B29C 48/21; B29C 48/00; B29C 48/255; B32B 7/12; B32B 27/08; B32B 27/32

(52) U.S. Cl. CPC B29C 48/307; B29C 48/21; B29C 48/022; B29C 48/2556; B32B 7/12; B32B 27/08; B32B 27/32; B29K 2023/12

(57) ABSTRACT

Described is a coextrusion head (1) comprising a plurality of infeeds (11, 12, 13, 14, 15) for fluid products, an inner joining space (16, 17), positioned downstream of said infeeds and communicating with them by means of respective delivery ducts (110, 120, 130, 140, 150) so as to allow flows of products to converge there and an outfeed (18) for the final multi-layer product, positioned downstream of the inner joining space (16, 17). In the head (1) there is a central delivery duct (110), provided for receiving a first flow of product and two lateral delivery ducts (120, 130), designed to receive, respectively, a second flow of product and a third flow of product. The head (1) also comprises adjustable narrowing means (31, 32), acting at least in the central delivery duct (110) and designed to vary a respective opening, to allow adjustment of the relative position of the first flow relative to a composite secondary flow defined by the joining of the first, second and third flow in the joining space (16) .

### TECHNICAL FIELD

This invention relates to a multi-layer coextrusion head.

In particular, the invention has been especially, but not exclusively, designed for making a coextruded material, for example which can be used in the packaging of food products, which comprises amongst others a “barrier layer”, that is to say, a layer impermeable to oxygen.

### BACKGROUND ART

There are prior art coextrusion heads which make a multi-layer film made of plastic material.

More in detail, especially in the field of packaging food products, such as, for example, single-dose coffee capsules, the prior art teaches the production by coextrusion of a film which includes outer layers of polypropylene, or another polyolefin, and a central barrier layer, joined to the previous layers by suitable adhesive layers.

The barrier layer can be ethylene vinyl alcohol (“EVOH”) or a different type of polymer impermeable to oxygen.

Depending on the type of application, it may be desirable that the barrier layer is off-centre inside the film, along one or more of its transversal directions of extension, or in any case, more generally speaking, that the centring is suitably adjusted.

The market does not currently provide coextrusion heads which allow the above-mentioned need to be satisfied in a precise and versatile manner, splitting it relative to the various uses which the multi-layer films may have, starting from the many applications in the food sector and arriving at the agricultural, biomedical or packaging sectors etc.

### DISCLOSURE OF THE INVENTION

The technical purpose which forms the basis of the invention is therefore to provide a coextrusion head which is able to overcome the drawbacks of the prior art.

This aim is achieved by using the coextrusion head made according to claim 1 and use the coextrusion method actuated according to claim 16.

The coextrusion head according to the invention comprising a plurality of infeeds for the fluid products, an inner joining space, located downstream of said infeeds and communicating with them by means of respective delivery ducts so as to allow flows of said products to flow into them.

Moreover, the head according the invention includes an outfeed downstream of the internal joining space and a central delivery duct, provided to receive a first flow of product and two or more lateral delivery ducts, which are provided to receive, respectively, a second flow of product and a third flow of product.

The head then comprises adjustable narrowing means, acting at least in the central delivery duct and designed to vary a respective opening, allowing adjustment of the relative position of the first flow relative to the composite flow formed inside the joining space.

Since the configuration of the opening of the duct of the first flow can be changed in an adjustable fashion, before the latter joins another two flows which it meets in the joining space, thus determining the relative position between the first flow and the other two, inside the secondary flow formed by them, the invention makes it possible to obtain a final multi-layer product in which the relative position of one or more inner layers is established as desired by the user.

### BRIEF DESCRIPTION OF DRAWINGS

In the case of a ribbon-like multi-layer product which comprises a barrier layer in the sense used in the introduction, the invention makes it possible to establish exactly how close or how far it must be from the short sides of the rectangular cross-section of the ribbon, as well as providing several advantageous results which will be explained in detail in the following description of a preferred, non-limiting embodiment of a coextrusion head according to the invention, as illustrated in the accompanying drawings, in which:

FIG. 1 is a schematic view of a plant which uses the coextrusion head according to the invention;

FIG. 2 is a longitudinal cross-section of the coextrusion head according to the invention, taken in a vertical plane;

FIG. 3 is a longitudinal cross-section of the head, taken in a vertical plane perpendicular to that of FIG. 3; and

FIGS. 4, 5, 6 and 7 are schematic representations of the transversal cross-section of the multi-layer product which can be obtained with the invention, according to various adjustments which can be performed by the user.

### DETAILED DESCRIPTION OF PREFERRED EMBODIMENTS OF THE INVENTION

With reference to the accompanying drawings, the numeral 1 denotes a coextrusion head made according to the invention.

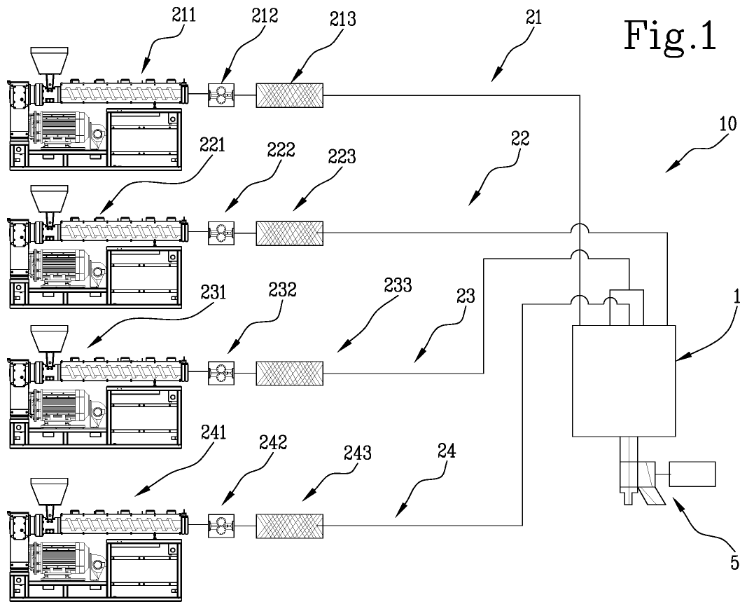

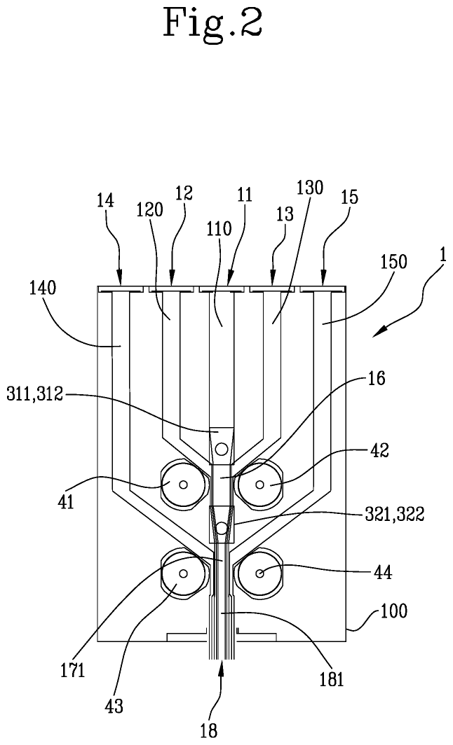

The head 1 according to the invention is especially designed to be used in a coextrusion system 10, illustrated schematically in FIG. 1, which includes a plurality of feed lines 21, 22, 23, 24 connected to the infeeds 11, 12, 13, 14, 15 of the head 1 (shown in FIG. 2), the lines each comprising an extruder 211, 221, 231, 241, designed to supply an extruded fluid product, and a pump 212, 222, 232, 242, with an adjustable flow rate, which feeds the flow of extruded product to one or more of the infeeds 11, 12, 13, 14, 15.

More specifically, each line 21, 22, 23, 24 may include the extruder 211, 221, 231, 241 upstream of the above-mentioned pump 212, 222, 232, 242 and downstream of it a static mixer 213, 223, 233, 243 is connected to one or more infeeds 11, 12, 13, 14, 15 of the head 1.

In the example shown, the coextrusion head 1 has five infeeds 11, 12, 13, 14, 15 which are connected to four feeding lines 21, 22, 23, 24.

In its preferred application, the invention comprises a first line 24 for feeding a flow of extruded material impermeable to oxygen, such as ethylene vinyl alcohol, connected to a central infeed 11 of the head 1, a second line 24 for feeding adhesive material which branches off and is connected to two lateral infeeds 12, 13 and then a third and a fourth line 21, 22 for feeding a plastic material such as polypropylene or other similar polymers, which connect to a fourth and fifth lateral infeed 14, 25.

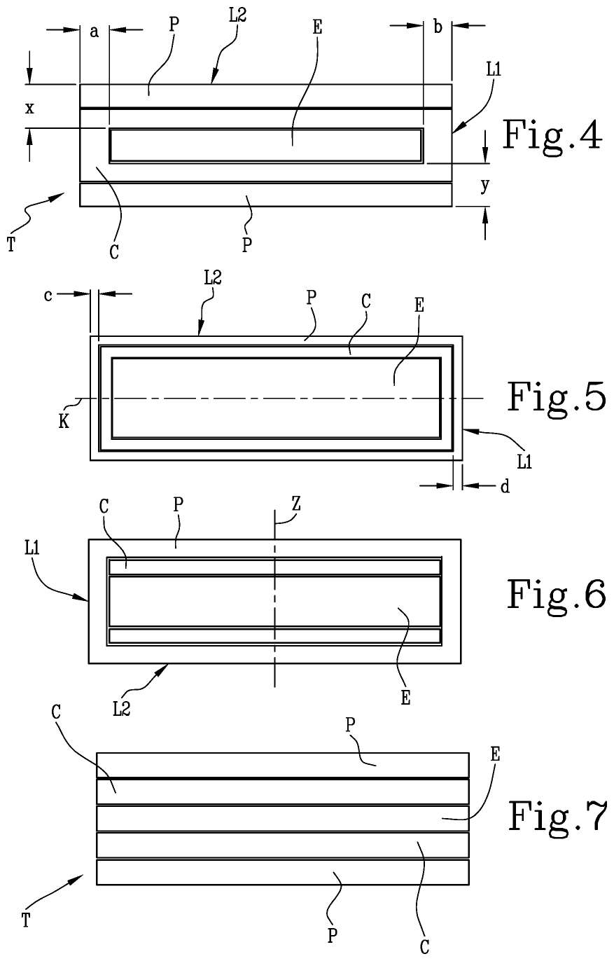

Basically, the invention has been especially, although not exclusively, designed for making a multi-layer product, with a rectangular cross-section (labelled T, in FIGS. 4 to 7), that is to say, a so-called “ribbon”, which includes a central layer with an oxygen barrier E, one or more outer layers of propylene P and one or more inner layers of glue C, interposed between the barrier layer E and the polypropylene P, to allow mutual adhesion of the latter.

The continuous multi-layer product exiting from the head 1 according to the invention may be portioned to make, for example, single-use coffee capsules or for other applications of the food industry and other applications.

As will become clearer in the following description, in the case of the preferred application described above, the invention advantageously allows the transversal position of the barrier layer E to be adjusted in the ribbon, along the longitudinal direction of its transversal section T, that is to say, an adjustment of its distances a, b relative to the short sides L1 of the section itself.

It should be noted that, using some preferred but not binding features, the invention also allows an adjustment of the position of the barrier layer E in the direction orthogonal to the longitudinal direction K of the section T indicated above and also an adjustment of the thickness of the layers.

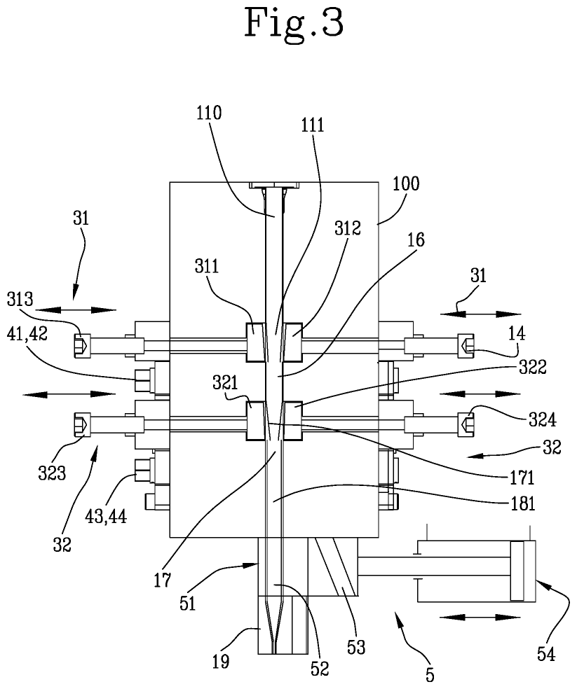

As already partly mentioned, the coextrusion head according to the invention, shown in FIGS. 1, 2 and 3, comprising a plurality of infeeds 11, 12, 13, 14, 15 for the extruded fluid products, at least one inner joining space 16, 17 of the flows of product, positioned downstream of the infeeds 11, 12, 13, 14, 15 and communicating with them using respective and separate delivery ducts 110, 120, 130, 140, 150, so as to allow the flows of said products to converge there and an outfeed 18 for the final multi-layer product, located downstream of the inner joining space 16, 17. Preferably, the head 1 is made of a metallic material, may be defined by a main body 100 consisting of two specular half-bodies, the joining of which defines the inner ducts in which the flows of extruded materials flow.

The body 100 also has accesses to the ducts where to house the adjustment means described below.

In the head 1 there is a central delivery duct 110 and several lateral delivery ducts 120, 130, 140, 150, for example a second and a third lateral duct 120, 130 opposite the first central duct 110 and a fourth and a fifth lateral delivery duct 140, 150, again opposite the first duct 110 and located more outside with respect to the others.

The first duct 110, which is accessed with the first infeed 11, conveys the flow of barrier material, the second and third ducts 120, 130 convey the glue received from the second and third infeeds 12, 13 and the fourth and fifth ducts 140, 150 convey the polypropylene which is accessed through the fourth and fifth infeeds 14, 15.

The head 1 is preferably oriented with the infeeds 11, 12, 13, 14, 15 at the top and the outfeed 18 at the bottom, the feed direction of the flows of material therefore being descending.

The first, the second and third ducts 110, 120, 130 merge into a first inner joining space 16, which communicates with a second inner joining space 17 by means of a joining duct 171, there also being a drawing duct 181 between the second inner space 17 and the outfeed 18.

The outfeed 18 may be quadrangular and, preferably, it is rectangular, so as to make an end product with a ribbon-like multi-layer, which has a rectangular cross section.

The various ducts inside the head 1 mentioned above may also have a substantially rectangular cross-section, at least over a main part of its length.

Preferably, the central delivery duct 110, the first joining space 16, the joining duct 171, the drawing duct 181 and the outfeed 18 are aligned, to define a continuous central fluid dynamic path.

Further, all the ducts may be defined on a same mid-plane of the coextrusion head 1.

According to an important aspect of the invention, the head 1 comprises adjustable narrowing means 31, 32, acting at least in the central delivery duct 110 and designed to vary the respective opening, to allow adjustment of the relative position of the first flow relative to a composite secondary flow produced by joining the first, second and third flow in the joining space 16, 17.

Basically, narrowing means 31, 32 which are controlled in an adjustable manner by the user and which allow the shape and dimension of the opening of the first duct 110 to be varied, that is to say, the shape and dimension of its transversal cross-section, act in a cross-section 111 of the first central duct 110, preferably located immediately before its outlet in the first joining space 16.

This adjustment changes the position in which the first flow, preferably comprising the barrier material, enters the inner joining space 16, which is defined in a cavity made in the body of the head 1.

Still more in detail, the cross-section or stretch 111 of the first duct 110 in which the narrowing means 31 operate is provided with a taper, that is to say, a narrowing of the transversal dimensions, in the feed direction of the first flow, which is in practice the vertical direction; the taper is defined in the direction of the length of the rectangular cross-section of the first duct, parallel to the direction in length of the rectangular cross-section of the first joining space 16.

The narrowing means 31 act on a direction transversal to the feed direction of the first flow which is parallel to the length (or longitudinal central axis) of the rectangular cross-section of the first joining space 16, so that the position of the first flow relative to the short sides of the cross-section of the space 16 can be adjusted.

The dimensions of the first joining space 16 are selected in such a way that the space not occupied by the first flow is occupied by the second and third flow.

According to the preferred embodiment of the invention, the narrowing means 31, 32 include at least two opposite intercepting elements 311, 312, 321, 322, that is to say, opposite each other, movable independently, in such a way as to change the transversal cross-section of the first duct 110.

The intercepting elements 311, 312, 321, 322 are guided in a straight line movement along the longitudinal direction of the above-mentioned section 111 of the first duct 110, and can, for example, be operated by respective screws 313, 314, 323, 324, the head of which is accessible externally.

Preferably, each intercepting element has a shaped head 311, 312, 321, 322 designed to move in the first duct 110 between a retracted position in which it is positioned outside the duct 110 and a plurality of advanced positions at which it penetrates in the duct, modifying the opening.

Still more in detail, the shaped head 311, 312, 321, 322 of the intercepting elements may be equipped with a wall facing the inside of the duct in which it acts, which is inclined with respect to the central axis of the duct itself, that is to say, the vertical axis of feeding the flow, to define a taper downwards or in any case in the same direction as the feed direction.

As mentioned above, the first and second inner joining spaces 16, 17 communicate with each other through a joining duct 171, in which flows the secondary flow formed by the barrier and glue layer and the fourth and fifth delivery ducts 14, 15 also lead to the second joining space 17.

There are also second narrowing means 32, preferably equal to the first means 31 described above, acting in the joining duct 171, upstream of the second joining space 17.

Basically, what is stated with regard to the shape and function of the first narrowing means 31, of the cross-section 111 of the first duct 110 in which they act and of the first joining space 16, may be applied identically to the second narrowing means 31, to a respective cross-section of the joining duct 171 in which they act (which may or may not substantially coincide with the joining duct 171) and to the second joining space 17, except that the second narrowing means 32 allow adjustment of the relative position of the above-mentioned secondary flow inside a joint composite flow, which is formed in the second joining space 17 together with the fourth and fifth flow of product, preferably consisting of polypropylene.

Thanks to the second narrowing means 32, it is possible to determine the distances c, d between the inner tri-layer core glue-barrier-glue and the short sides L1 of the cross-section T of the ribbon.

Moreover, the head 1 according to the invention can also include means for varying the adjustable thickness 41, 42, 43, 44, designed to act in the lateral ducts 120, 130, 140, 150, and designed to adjust the thickness of the second and/or third and/or fourth and/or fifth flow of product.

More precisely, the variation means may comprise shaped elements 41, 42, 43, 44 which can be operated individually and equipped with a plurality of active members having different dimensions, which can be selectively positioned in the respective lateral duct.

For example, the shaped elements might consist of shaped pins 41, 42, 43, 44 provided with a plurality of lateral surfaces of different dimensions, spaced at angular intervals, to allow the selection by rotating the pin.

Preferably, the intercepting elements 311, 312, 321, 322 of the above-mentioned narrowing means 31, 32 are positioned and act in a plane which is transversal to the plane in which the active members of the shaped elements 41, 42, 43, 44 of the thickness variation means are positioned and act.

For this reason, varying the dimension of the above-mentioned surfaces, or other active members of the means for varying the thickness 41, 42, 43, 44, varies the transversal dimensions of the lateral ducts 120, 130, 140, 150 which carry the flows of glue or polypropylene, thereby determining the thickness in the direction of width Z of the rectangular cross-section T of the ribbon.

An operation of the invention is described below.

Depending on the specific application of the multi-layer product, the operator adjusts the four screws 313, 314, 323, 324 of the narrowing means 31, 32 (or acts on commands which automatically adjust these means), suitably positioning the shaped pins 41, 42, 43, 44 which adjust the means for varying the thickness and selects the flow rate of the pumps, with particular reference to the flow rate of the pumps 212, 222 of the lines 21, 22 which feed the polypropylene.

After that, the plant starts sending the flows of extruded material to the infeeds 11, 12, 13, 14, 15 of the head 1 for making the multi-layer product. The flow of the barrier layer drops through the first duct 110 and meets the first adjusting means 31; based on how the screws 313, 314 have been positioned, the intercepting elements 311, 312 define a specific configuration of the opening of the duct 110, which determines the way in which the first flow of barrier material enters the first joining space 16 and therefore how it is positioned relative to the flows of glue, in the secondary flow, relative to the direction of the length of the section of the latter.

Meanwhile, based on how the pins 41, 42 of the first thickness adjustment means are oriented, the two glue flows find a different opening of the respective duct 12, 13 and, in the composite secondary flow, the respective layers adopt a specific thickness, in the direction of the width Z of its section T, with which the thickness of the barrier layer E is also automatically established.

At this point, the composite flow drops along the joining duct 171 where it encounters the second adjusting means 32 which determine the mode in which it enters the second joining space 17, thereby also determining its position in the direction of the length J of the transversal cross-section K of the joint flow which forms by the meeting with the polypropylene flows.

To understand still more clearly how the position of the inner layers in the ribbon can be adjusted, specific reference may be made to FIGS. 4 to 7. When none of the intercepting elements 311, 312, 321, 322 is fed into the respective ducts 110, 171 by the user, for example by acting on the above-mentioned screws 313, 314, 323, 324, and hence the narrowing means 31, 32 are inactive, the layers are positioned in the product coming out of the head 1 in the manner shown in FIG. 7.

In fact, in that case, the barrier layer E is not laterally constrained by the heads of the respective two intercepting elements 311, 312 and therefore adopts, in a transversal direction Z, the same length as the layers of glue C. The same applies to the core with three central layers of glue-barrier-glue relative to polypropylene P, if the intercepting elements 321, 322 of the second narrowing means 32 remain inactive.

If only the first narrowing means 31 are on, the configuration of FIG. 4 is obtained, if only the second means 32 are active, then the transversal cross section of the ribbon is as shown in FIG. 6 and, lastly, with all the narrowing means 31, 32 active the configuration of FIG. 5 is reached.

In the meantime, the polypropylene has undergone two adjustments, one relating to its thickness using the pins 43, 44 of the specific means described several times, and one relating to the flow rate difference of the respective pumps 212, 222 which affects the relative position of the barrier E and the glue C layers in the direction of the width Z of the transversal cross-section T of the composite flow, that is, the one perpendicular to the direction of adjustment of the narrowing means 31, 32.

In effect, based on the gradient and the sign of the difference between the two flow rates, there is a greater or lesser thrust in one direction or the other by the polypropylene to the inner core formed by the barrier E and glue C layers.

In this way, it is possible, in particular, to determine as desired the distances x, y between the barrier layer E and the long sides L2 of the transversal cross-section T of the multi-layer or ribbon product.

At this point, the multi-layer ribbon, having exactly the configuration desired by the user, comes out from the rectangular outfeed 18.

The invention also relates to a coextrusion method for making a multi-layer product, which may be actuated by means of the coextrusion head 1 according to the invention.

The method comprises the following steps:
providing at least a first, a second and a third flow of extruded products;
joining the three flows so that the first flow is interposed between the second and the third, thereby obtaining a composite secondary flow with rectangular section;
adjusting the position of the first flow relative to the second and/or to the third along at least a longitudinal line of the cross-section of said composite secondary flow.

Preferably, the step of adjusting the position of the first flow is performed by adjusting the transversal cross-section before the step of joining with the second and third flow.

A third and a fourth flow of product may also be made available and, in this case, the method comprises the following steps:
joining the composite secondary flow, obtained by joining the first, the second and the third flow, to the third and the fourth flow so that the secondary flow is interposed between the third and the fourth flow, thereby obtaining a composite joint flow; and
adjusting the position of the secondary flow relative to the third and/or fourth flow along at least a longitudinal line of the cross-section of said composite joint flow.

Preferably, the step of adjusting the position of the secondary flow is performed by adjusting the transversal cross-section before the step of joining with the fourth and fifth flow.

In the embodiment of the method implemented also by the plant described above, the first flow consists of material which is impermeable to oxygen, the second and the third flows consist of adhesive material and the fourth and fifth flows consist of polymer, preferably polypropylene.

Preferably, the invention comprises a step of adjusting the thickness of the layers of glue C and/or polypropylene P (that is, more generally, of the second and/or third and/or fourth and/or fifth layers), wherein the transversal cross-section of the respective flows is adjusted, before joining to define said second composite flow and/or third composite flow, in a direction transversal to that affected by the above-mentioned step(s) of adjusting the position.

Basically, before the glue joins the flow of the barrier layer and/or the polypropylene joins with the glue-barrier-glue triple layer flow, the relative flows undergo variations in the transversal dimensions of the respective flows so that, in the final product, there are layers with dimensions, in the direction Z parallel to the short sides L1 of the cross section T of the ribbon, which are established as desired by the user.

Moreover, the relative position of the inner glue-barrier-glue layers, in the direction Z parallel to the short sides L1 of the transversal cross-section T of the multi-layer product, can be adjusted by varying the flow rate difference of the polypropylene flows (or other material used in the fourth and fifth flows), on the basis of the principles already illustrated during explanation of the operation of the coextrusion head 1 according to the invention.

Lastly, a preferred feature of the plant according to the invention is described below.

In a step for starting or stopping the plant, and in the transient step between the coextrusion of two different types of multi-layer products, the plant 10 is activated for a step for cleaning the ducts or, as it is known in the trade, “purging”.

During this step, the material exiting from the head 1 is to be considered waste and must be sent towards a disposal container and not towards the nozzle 19; when, on the other hand, the normal activities of the plant restart, the multi-layer product exiting from the head 1 must be sent to the dispensing nozzle 19 or in any case to its production destination.

A routing device 5, defined as the bypass, has been designed to allow selective routing of the product at the outfeed from the head 1 to the nozzle 19 or to the container, which is provided with a “drawer”, comprising a movable body 51 in which two routing connectors 52, 53 are made which allow the passage of the multi-layer product.

A first connector 52 is rectilinear and is coaxial with the feed direction of ribbon at the outfeed 18 from the head 1 and is therefore, in practice, vertical.

The second connector 53, located alongside the first connector, may also be rectilinear and has a longitudinal axis which is oblique relative to that of the first connector 52.

The drawer 51 is movable on the actuation of translation means 54, such as a hydraulic or pneumatic actuator or similar movement means, between at least two positions of which one an operating position, in which the first duct 52 is aligned with the outfeed 18 of the head 1 and with the infeed of the nozzle 19 and a preparation position in which the infeed of the second duct 53 directly faces the outfeed 18 of the head 1 and allows the rejected product to be directed towards the collection container.

30

1. A coextrusion head (1), comprising a plurality of infeeds (11, 12, 13, 14, 15) for fluid products, at least one inner joining space (16, 17), positioned downstream of said infeeds and communicating with them by means of respective delivery ducts (110, 120, 130, 140, 150) so as to allow flows of said products to converge there and an outfeed (18) for the final multi-layer product, positioned downstream of said inner joining space (16, 17), wherein in said head (1) there is a central delivery duct (110), provided for receiving a first flow of product and at least two lateral delivery ducts (120, 130), provided for receiving respectively a second flow of product and a third flow of product, the head (1) comprising: adjustable narrowing means (31, 32), acting at least in the central delivery duct (110) and suitable for varying its relative opening, to allow adjustment of the relative position of the first flow relative to a composite secondary flow defined by the joining of the first, second and third flow in the joining space (16); and comprising adjustable thickness varying means (41, 42, 43, 44), suitable for acting in said lateral ducts (120, 130, 140, 150) and suitable for adjusting the thickness of the second and/or third and/or fourth and/or fifth flow of product;
wherein the varying means comprise at least respective shaped elements (41, 42, 43, 44), each provided with a plurality of active members having different dimensions, selectively positionable in the relative duct;
the head being characterized in that the intercepting elements (311, 312, 321, 322) of the above-mentioned narrowing means are positioned and act in the same plane which is transversal to a plane in which the active members of the shaped elements (41, 42, 43, 44) of the above-mentioned thickness varying means are positioned and act.

2. The head (1) according to claim 1, wherein said narrowing means include at least two opposite intercepting elements (311, 312, 321, 322), which are independently movable.

3. The head (1) according to claim 2, wherein each intercepting element has a shaped head (311, 312, 321, 322) suitable for moving in the respective duct (110, 171) between a retracted position in which it is positioned outside the duct and a plurality of forward positions in which it penetrates in the duct.

4. The head (1) according to claim 3, wherein said shaped head (311, 312, 321, 322) of the intercepting elements is provided with a wall facing towards the inside of the relative duct (110, 171) which is angled relative to a central axis of the self-same duct, to define there a taper towards a downstream direction.

5. The head (1) according to claim 1, comprising at least one drawing duct (181), defined between the joining space (16, 17) and said outfeed (18), the central delivery duct (110), the joining space (16, 17) and said drawing duct (181) being aligned, to define a central continuous path towards the outfeed (18).

6. The head (1) according to claim 1, comprising at least five infeeds (11, 12, 13, 14, 15), of which one is central (11) and four lateral (12, 13, 14, 15), provided for receiving respective fluid products, which enter respectively the central delivery duct (110), or first duct and four lateral delivery ducts (120, 130, 140, 150), and also comprising a first and a second inner meeting space (16, 17), communicating through a joining duct (171), wherein a second and a third lateral delivery duct (120, 130), on opposite sides of the first duct (110), open into the first inner space (16) and a fourth and a fifth lateral delivery duct (140, 150) on opposite sides of the central duct (110), open into the second joining space (17), first and second narrowing means (31, 32) also being provided, acting respectively in the central delivery duct (110), upstream of the first joining space (16) and in the joining duct (171), upstream of the second joining space (17), the above-mentioned second narrowing means (32) being suitable for varying the opening of the joining duct (171), to allow adjustment of the relative position of said composite secondary flow in a joint composite flow, defined in the second joining space (17) and comprising a fourth and a fifth flow of product which pass respectively in said fourth and fifth delivery duct (140, 150).

7. The head (1) according to claim 1 wherein, the narrowing means (31, 32) act in a stretch of the respective duct (110, 171) which is provided with a taper in a direction of forward movement of the flow of product.

8. The head (1) according to claim 6, wherein the joining duct (171) and the second joining space (17) are aligned with the central delivery duct (110), with the first joining space (16) and with the drawing duct (181), the latter being positioned downstream of the second joining space (17), thereby defining the same central continuous path.

9. The head (1) according to claim 1, wherein the outfeed (18) is rectangular.

10. The head (1) according to claim 1, wherein the joining space or spaces (16, 17), have a rectangular section and the narrowing means (31, 32) act along a line parallel to a longitudinal line of said section, thereby adjusting how near to or far from the short sides of the section the flow/flows affected by the self-same narrowing means are.

11. A coextrusion plant, comprising a head (1) according to claim 1 and also comprising a plurality of feeding lines (21, 22, 23, 24) connected to said infeeds (11, 12, 13, 14, 15), those lines each comprising an extruder (211, 221, 231, 241) suitable for supplying an extruded fluid product and a pump (212, 222, 232, 242), with adjustable flow rate, which feeds the flow of extruded product to at least one of said infeeds (11, 12, 13, 14, 15).

12. A plant, comprising a head (1) according to claim 6, wherein one of said feeding lines (24) is connected to the central delivery duct (110) and two separate lines (211, 221) are connected to the fourth and fifth delivery duct (140, 150), to allow a variation of the flow rate in the fourth and fifth flow to change the relative position of the first, second and third flow which are joined relative to the fourth and fifth flow.

13. A coextrusion method for making a multi-layer product, comprising the following steps:
making available at least a first, a second and a third flow of extruded products;
joining the three flows so that the first flow is interposed between the second and the third, thereby obtaining a composite secondary flow with rectangular section;
adjusting the position of the first flow relative to the second and/or to the third along at least a longitudinal line of the cross-section of said composite secondary flow;
making available a third and a fourth flow of products;
joining the composite secondary flow, obtained by joining the first, the second and the third flow, to the third and the fourth flow so that the secondary flow is interposed between the third and the fourth flow, thereby obtaining a composite joint flow; and
adjusting the position of the secondary flow relative to the third and/or fourth flow along at least a longitudinal line of the cross-section of said composite joint flow.

14. The method according to claim 13, wherein the step of adjusting the position of the first flow is performed by adjusting its cross-section before the step of joining with the second and third flow.

15. The method according to claim 14, wherein the step of adjusting the position of the secondary flow is performed by adjusting its cross-section before the step of joining with the fourth and fifth flow.

16. The method according to claim 13, wherein the first flow is of material impermeable to oxygen, wherein, the second and the third flow are of adhesive material and the fourth and fifth flow are of polypropylene, wherein the relative position of the first flow is adjusted relative to the composite secondary flow and the relative position of the latter is adjusted relative to the composite joint flow.
